(19) United States
(12) Patent Application Publication
(10) Pub. No.: US 2026/0159617 A1
(43) Pub. Date: Jun. 11, 2026

(54) Amide Activation Approach to the Post-Polymerization Modification of Poly(meth)acrylamides

(71) Applicant: UNIVERSITY OF KANSAS, Lawrence, KS (US)

(72) Inventors: Aaron J. TEATOR, Lawrence, KS (US); Kasun WEKASINGHE, Lawrence, KS (US)

(21) Appl. No.: 19/083,194

(22) Filed: Mar. 18, 2025

Related U.S. Application Data
(60) Provisional application No. 63/566,647, filed on Mar. 18, 2024.

(51) Int. Cl. C08F 20/56; C08F 8/12; C08F 8/24; C08F 8/30

(52) U.S. Cl. CPC C08F 20/56; C08F 8/12; C08F 8/24; C08F 8/30

(57) ABSTRACT

Described herein are methods for the post-polymerization modification of a (co)polymer comprising a monomer repeat unit comprising a pendant secondary or tertiary amide moiety (e.g., an acrylamide or a methacrylamide (co)polymer). These methods can comprise activating the pendant secondary or tertiary amide moiety to form a keteniminium ion or a nitrilium ion; and quenching the keteniminium ion or the nitrilium ion with a nucleophile to covalently functionalize the monomer repeat unit. Also provided herein are copolymers prepared by these methods.

A. Previous Work

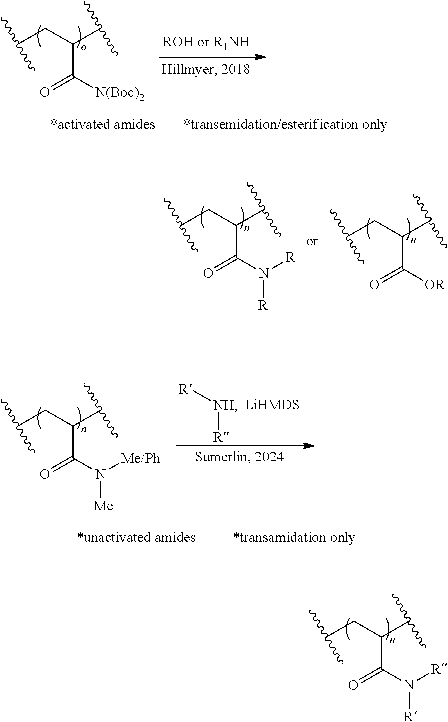

B. This Work

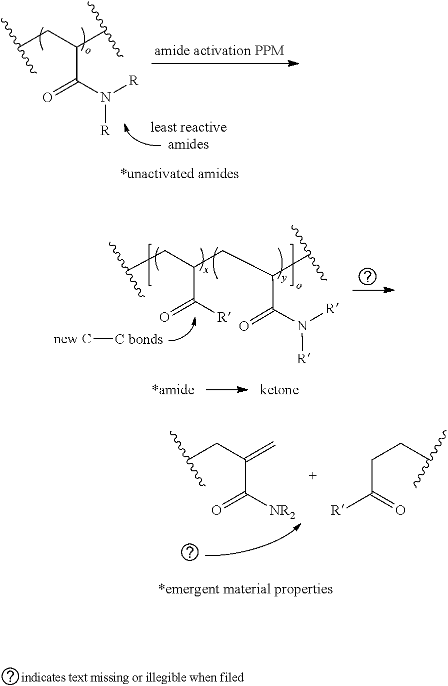

### CROSS-REFERENCE TO RELATED APPLICATIONS

This application claims benefit of priority of U.S. Provisional Application No. 63/566,647, filed Mar. 18, 2024, which is incorporated herein by reference in its entirety.

### BACKGROUND

The identity and spatial arrangement of functional groups along a polymer backbone play an important role in determining the ultimate utility of a given synthetic material. The most direct method for adding functionality to a polymer involves the homopolymerization or copolymerization of monomers containing the desired functional groups. Decades of research involving controlled radical polymerization (CRP) techniques has broadly expanded our access to materials bearing a wide variety of functionality, however, significant challenges remain. Designing specific functional sequences de novo is complicated by numerous factors, including comonomer reactivity mismatch that results in often undesirable non-random distributions of functionality. New methodologies that expand the structure space accessible through controlled polymerization methods is a particular focus of modern polymer science. Such efforts offer the potential to provide new polymeric materials.

### SUMMARY

Provided herein are methods for the post-polymerization modification of a (co)polymer comprising a monomer repeat unit comprising a pendant secondary or tertiary amide moiety. These methods can comprise activating the pendant secondary or tertiary amide moiety to form a keteniminium ion or a nitrilium ion; and quenching the keteniminium ion or the nitrilium ion with a nucleophile to covalently functionalize the monomer repeat unit.

In some embodiments, the (co)polymer comprises a (meth)acrylamide (co)polymer.

In some embodiments, the monomer repeat unit comprising the pendant secondary or tertiary amide moiety is defined by the structure below

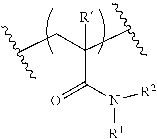

wherein R¹ and R² are individually hydrogen or substituted or unsubstituted C1-C12 alkyl, C2-C12 alkenyl, C2-C12 alkynyl, cycloalkyl, heterocycloalkyl, aryl, or heteroaryl, or R¹ and R² together with the atom to which they are attached form a substituted or unsubstituted cycloalkyl or heterocycloalkyl ring, with the proviso that only one of R¹ and R² can be hydrogen; and R′ is hydrogen or methyl.

In some embodiments, the monomer repeat unit is derived from polymerization of a (meth)acrylamide monomer chosen from acrylamide, methacrylamide, N-methylacrylamide, N-methylmethacrylamide, N-ethylacrylamide, N-ethylmethacrylamide, N-butylacrylamide, N-butylmethacrylamide, N,N-dimethylacrylamide, N,N-dimethylmethacrylamide, N-(3-methoxypropoyl)acrylamide (MPAM), 4-acryloylmorpholine (MORPH), N,N-dimethylacrylamide (DMA), N-hydroxyethyl acrylamide (HEAM), N-[tris(hydroxymethyl)-methyl]acrylamide (TRI), 2-acrylamido-2-methylpropane sulfonic acid (AMP), (3-acrylamidopropyl)trimethylammonium chloride (TMA), N-isopropyl acrylamide (NIP), N,N-diethylacrylamide (DEA), N-tert-butyl acrylamide (TBA), N-[3-(dimethylamino)propyl]acrylamide, and N-phenyl acrylamide (PHE).

In some embodiments, activating the secondary or tertiary amide moiety comprises contacting the secondary or tertiary amide moiety with a strong electrophile, such as trifluoromethanesulfonic anhydride (Tf₂O), N-Phenyl(trifluoromethane)sulfonamide, N,N-Bis(trifluoromethylsulfonyl)aniline, 4-Nitrophenyl Trifluoromethanesulfonate, N-(5-Chloro-2-pyridyl)bis(trifluoromethanesulfonyl)imide, 1-(Trifluoromethanesulfonyl)imidazole, or 1-(Trifluoromethanesulfonyl)-1H-benzotriazole.

In some embodiments, the secondary or tertiary amide moiety is contacted with the strong electrophile in the presence of a non-nucleophilic base, such as a nitrogenous base. In some embodiments, the nitrogenous base comprises a pyridyl base, such as a pyridyl base, such as pyridine, 2-fluoropyridine, 2-bromopyridine, 2-iodopyridine, 2-chloropyridine 2,4,6-trimethylpyridine, 2,6-di-tert-butyl-4-methylpyridine, 2-fluoro-5-iodopyridine, 2-chloro-6-fluoropyridine, pentafluoropyridine, 2,6-difluoropyridine, or 2-fluoro-6-methylpyridine.

In some embodiments, the nucleophile comprises a Grignard reagent, such as a Grignard reagent defined by R^{B}—MgX, where X is a halide (e.g., Cl or Br) and R^{B} is substituted or unsubstituted alkyl, alkenyl, alkynyl, cycloalkyl, heterocycloalkyl, aryl, or heteroaryl. In certain embodiments, the nucleophile comprises a Grignard reagent, such as a Grignard reagent defined by R^{B}—MgX, where X is a halide (e.g., C1 or Br) and R^{B} is substituted or unsubstituted aryl or heteroaryl.

In some embodiments, following quenching of the keteniminium ion or the nitrilium ion with the nucleophile to covalently functionalize the monomer repeat unit, the monomer repeat unit is defined by the structure below

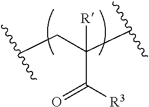

wherein R³ is a substituted or unsubstituted alkyl, alkenyl, alkynyl, cycloalkyl, heterocycloalkyl, aryl, or heteroaryl group; and R′ is hydrogen or methyl. In some embodiments, R³ is a substituted or unsubstituted aryl or heteroaryl group. In certain embodiments, R³ is a substituted or unsubstituted aryl group.

In some embodiments, upon covalently functionalization of the monomer repeat unit, the polymer is UV degradable. For example, in some embodiments, upon covalent functionalization of the monomer repeat unit, the monomer repeat unit can undergo a Norrish type 2 radical fragmentation under UV irradiation, thereby cleaving the (co)polymer backbone.

In some embodiments, from 1 mol % to 30 mol % of the monomer repeat units comprising the pendant secondary or tertiary amide moiety in the (co)polymer are covalently functionalized.

In some embodiments, following quenching of the keteniminium ion or the nitrilium ion with the nucleophile to covalently functionalize the monomer repeat unit, the (co)polymer comprises a random copolymer defined by the formula below

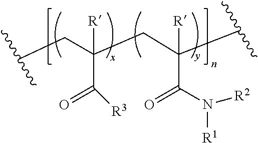

wherein R¹ and R² are individually hydrogen or substituted or unsubstituted C1-C12 alkyl, C2-C12 alkenyl, C2-C12 alkynyl, cycloalkyl, heterocycloalkyl, aryl, or heteroaryl, or R¹ and R² together with the atom to which they are attached form a substituted or unsubstituted cycloalkyl or heterocycloalkyl ring, with the proviso that only one of R¹ and R² can be hydrogen; R³ is a substituted or unsubstituted alkyl, alkenyl, alkynyl, cycloalkyl, heterocycloalkyl, aryl, or heteroaryl group; R′ is hydrogen or methyl; x is an integer from 1 to 25,000; y is an integer from 1 to 500,000; and n is an integer from 2 to 525,000.

Also provided herein are random copolymers that can be prepared using the post-polymerization modification strategies described herein. In many cases, these random copolymers were previously inaccessible via traditional polymerization methodologies (e.g., due to incompatibility of the requisite monomers with the polymerization process). For example, provided herein are random copolymers composed of (meth)acrylamide and (methyl)vinyl ketone repeat units.

In some embodiments, the random copolymer can be defined by the formula below

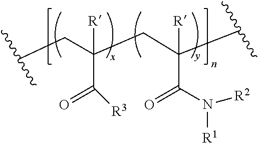

wherein R¹ and R² are individually hydrogen or substituted or unsubstituted C1-C12 alkyl, C2-C12 alkenyl, C2-C12 alkynyl, cycloalkyl, heterocycloalkyl, aryl, or heteroaryl, or R¹ and R² together with the atom to which they are attached form a substituted or unsubstituted cycloalkyl or heterocycloalkyl ring, with the proviso that only one of R¹ and R² can be hydrogen; R³ is a substituted or unsubstituted alkyl, alkenyl, alkynyl, cycloalkyl, heterocycloalkyl, aryl, or heteroaryl group; R′ is hydrogen or methyl; x is an integer from 1 to 25,000; y is an integer from 1 to 500,000; and n is an integer from 2 to 525,000.

In some embodiments, R³ is a substituted or unsubstituted aryl or heteroaryl group. In certain embodiments, R³ is a substituted or unsubstituted aryl group.

In some embodiments, the random copolymer is UV degradable.

Also provided herein are methods of producing UV degradable (meth)acrylamide copolymers. These methods can comprise activating a pendant secondary or tertiary amide moiety present in a (meth)acrylamide (co)polymer to form a keteniminium ion or a nitrilium ion; and quenching the keteniminium ion or the nitrilium ion with a nucleophile to form a monomer repeat unit is defined by the structure below

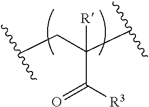

wherein R³ is a substituted or unsubstituted aryl group; and R′ is hydrogen or methyl.

In some embodiments, upon UV irradiation, the UV degradable (meth)acrylamide copolymer can undergo a Norrish type 2 radical fragmentation.

### DESCRIPTION OF DRAWINGS

FIGS. 1A-1B. An amide activation approach to post-polymerization modification of polyacrylamides enables the preparation of functional copolymers with emergent material properties (FIG. 1i), expanding beyond the transamidation/esterification featured in prior approaches (FIG. 1A).

FIGS. 2A-2E. Generation of keteniminium ions from unactivated pendant diethylamides, followed by nucleophilic quenching and subsequent hydrolysis to yield aryl ketones (FIG. 2A), along with ¹³C NMR (FIG. 2B) and IR spectroscopy (FIG. 2C) comparisons confirming the proposed copolymer structure. Increased functionalization efficiency was observed with higher loadings of Tf₂O (FIG. 2D), with no effect of molecular weight on functionalization (FIG. 2E).

FIGS. 3A-3C. Selected substrate scope of Grignard reagents and polyacrylamide precursors.

FIGS. 4A-4C. Illustration of the UV degradation of aryl ketone-functionalized polyacrylamides. FIG. 4A illustrates a Norrish type 2 fragmentation of aryl ketone-functionalized polyacrylamides. FIG. 4B shows a shift in GPC retention times with increased UV irradiation time. FIG. 4C illustrates an observed decrease in molecular weight during irradiation at 300 nm, 365 nm, and sunlight (Lawrence, KS).

### DETAILED DESCRIPTION

### Definitions

As used in the specification and the appended claims, the singular forms “a,” “an” and “the” include plural referents unless the context clearly dictates otherwise. Thus, for example, reference to “a pharmaceutical carrier” includes mixtures of two or more such carriers, and the like.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that when a value is disclosed that “less than or equal to” the value, “greater than or equal to the value” and possible ranges between values are also disclosed, as appropriately understood by the skilled artisan. For example, if the value “10” is disclosed the “less than or equal to 10” as well as “greater than or equal to 10” is also disclosed. It is also understood that the throughout the application, data is provided in a number of different formats, and that this data, represents endpoints and starting points, and ranges for any combination of the data points. For example, if a particular data point “10” and a particular data point 15 are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

In this specification and in the claims which follow, reference will be made to a number of terms which shall be defined to have the following meanings:

“Optional” or “optionally” means that the subsequently described event or circumstance may or may not occur, and that the description includes instances where said event or circumstance occurs and instances where it does not.

The term “n-membered” where n is an integer typically describes the number of ring-forming atoms in a moiety where the number of ring-forming atoms is n. For example, piperidinyl is an example of a 6-membered heterocycloalkyl ring, pyrazolyl is an example of a 5-membered heteroaryl ring, pyridyl is an example of a 6-membered heteroaryl ring, and 1,2,3,4-tetrahydro-naphthalene is an example of a 10-membered cycloalkyl group.

As used herein, the phrase “optionally substituted” means unsubstituted or substituted. As used herein, the term “substituted” means that a hydrogen atom is removed and replaced by a substituent. It is to be understood that substitution at a given atom is limited by valency.

Throughout the definitions, the term “Cₙ₋ₘ” indicates a range which includes the endpoints, wherein n and m are integers and indicate the number of carbons. Examples include C₁₋₄, C₁₋₆, and the like.

As used herein, the term “Cₙ₋ₘ alkyl”, employed alone or in combination with other terms, refers to a saturated hydrocarbon group that may be straight-chain or branched, having n to m carbons. Examples of alkyl moieties include, but are not limited to, chemical groups such as methyl, ethyl, n-propyl, isopropyl, n-butyl, tert-butyl, isobutyl, sec-butyl; higher homologs such as 2-methyl-1-butyl, n-pentyl, 3-pentyl, n-hexyl, 1,2,2-trimethylpropyl, and the like. In some embodiments, the alkyl group contains from 1 to 6 carbon atoms, from 1 to 4 carbon atoms, from 1 to 3 carbon atoms, or 1 to 2 carbon atoms.

As used herein, “Cₙ₋ₘ alkenyl” refers to an alkyl group having one or more double carbon-carbon bonds and having n to m carbons. Example alkenyl groups include, but are not limited to, ethenyl, n-propenyl, isopropenyl, n-butenyl, sec-butenyl, and the like. In some embodiments, the alkenyl moiety contains 2 to 6, 2 to 4, or 2 to 3 carbon atoms.

As used herein, “Cₙ₋ₘ alkynyl” refers to an alkyl group having one or more triple carbon-carbon bonds and having n to m carbons. Example alkynyl groups include, but are not limited to, ethynyl, propyn-1-yl, propyn-2-yl, and the like. In some embodiments, the alkynyl moiety contains 2 to 6, 2 to 4, or 2 to 3 carbon atoms.

As used herein, the term “Cₙ₋ₘ alkylene”, employed alone or in combination with other terms, refers to a divalent alkyl linking group having n to m carbons. Examples of alkylene groups include, but are not limited to, ethan-1,2-diyl, propan-1,3-diyl, propan-1,2-diyl, butan-1,4-diyl, butan-1,3-diyl, butan-1,2-diyl, 2-methyl-propan-1,3-diyl, and the like.

In some embodiments, the alkylene moiety contains 2 to 6, 2 to 4, 2 to 3, 1 to 6, 1 to 4, or 1 to 2 carbon atoms.

As used herein, the term “Cₙ₋ₘ alkoxy”, employed alone or in combination with other terms, refers to a group of formula —O-alkyl, wherein the alkyl group has n to m carbons. Example alkoxy groups include methoxy, ethoxy, propoxy (e.g., n-propoxy and isopropoxy), tert-butoxy, and the like. In some embodiments, the alkyl group has 1 to 6, 1 to 4, or 1 to 3 carbon atoms.

As used herein, the term “Cₙ₋ₘ alkylamino” refers to a group of formula —NH(alkyl), wherein the alkyl group has n to m carbon atoms. In some embodiments, the alkyl group has 1 to 6, 1 to 4, or 1 to 3 carbon atoms.

As used herein, the term “Cₙ₋ₘ alkoxycarbonyl” refers to a group of formula —C(O)O-alkyl, wherein the alkyl group has n to m carbon atoms. In some embodiments, the alkyl group has 1 to 6, 1 to 4, or 1 to 3 carbon atoms.

As used herein, the term “Cₙ₋ₘ alkylcarbonyl” refers to a group of formula —C(O)— alkyl, wherein the alkyl group has n to m carbon atoms. In some embodiments, the alkyl group has 1 to 6, 1 to 4, or 1 to 3 carbon atoms.

As used herein, the term “Cₙ₋ₘ alkylcarbonylamino” refers to a group of formula —NHC(O)-alkyl, wherein the alkyl group has n to m carbon atoms. In some embodiments, the alkyl group has 1 to 6, 1 to 4, or 1 to 3 carbon atoms.

As used herein, the term “Cₙ₋ₘ alkylsulfonylamino” refers to a group of formula —NHS(O)₂-alkyl, wherein the alkyl group has n to m carbon atoms. In some embodiments, the alkyl group has 1 to 6, 1 to 4, or 1 to 3 carbon atoms.

As used herein, the term “aminosulfonyl” refers to a group of formula —S(O)₂NH₂.

As used herein, the term “Cₙ₋ₘ alkylaminosulfonyl” refers to a group of formula —S(O)₂NH(alkyl), wherein the alkyl group has n to m carbon atoms. In some embodiments, the alkyl group has 1 to 6, 1 to 4, or 1 to 3 carbon atoms.

As used herein, the term “di(Cₙ₋ₘ alkyl)aminosulfonyl” refers to a group of formula —S(O)₂N(alkyl)₂, wherein each alkyl group independently has n to m carbon atoms.

In some embodiments, each alkyl group has, independently, 1 to 6, 1 to 4, or 1 to 3 carbon atoms.

As used herein, the term “aminosulfonylamino” refers to a group of formula —NHS(O)₂NH₂.

As used herein, the term “Cₙ₋ₘ alkylaminosulfonylamino” refers to a group of formula —NHS(O)₂NH(alkyl), wherein the alkyl group has n to m carbon atoms. In some embodiments, the alkyl group has 1 to 6, 1 to 4, or 1 to 3 carbon atoms.

As used herein, the term “di(Cₙ₋ₘ alkyl)aminosulfonylamino” refers to a group of formula —NHS(O)₂N(alkyl)₂, wherein each alkyl group independently has n to m carbon atoms. In some embodiments, each alkyl group has, independently, 1 to 6, 1 to 4, or 1 to 3 carbon atoms.

As used herein, the term “aminocarbonylamino”, employed alone or in combination with other terms, refers to a group of formula —NHC(O)NH₂.

As used herein, the term “Cₙ₋ₘ alkylaminocarbonylamino” refers to a group of formula —NHC(O)NH(alkyl), wherein the alkyl group has n to m carbon atoms. In some embodiments, the alkyl group has 1 to 6, 1 to 4, or 1 to 3 carbon atoms.

As used herein, the term “di(Cₙ₋ₘ alkyl)aminocarbonylamino” refers to a group of formula —NHC(O)N(alkyl)₂, wherein each alkyl group independently has n to m carbon atoms. In some embodiments, each alkyl group has, independently, 1 to 6, 1 to 4, or 1 to 3 carbon atoms.

As used herein, the term “Cₙ₋ₘ alkylcarbamyl” refers to a group of formula —C(O)—NH(alkyl), wherein the alkyl group has n to m carbon atoms. In some embodiments, the alkyl group has 1 to 6, 1 to 4, or 1 to 3 carbon atoms.

As used herein, the term “thio” refers to a group of formula —SH.

As used herein, the term “Cm alkylsulfinyl” refers to a group of formula —S(O)— alkyl, wherein the alkyl group has n to m carbon atoms. In some embodiments, the alkyl group has 1 to 6, 1 to 4, or 1 to 3 carbon atoms.

As used herein, the term “Cₙ₋ₘ alkylsulfonyl” refers to a group of formula —S(O)₂-alkyl, wherein the alkyl group has n to m carbon atoms. In some embodiments, the alkyl group has 1 to 6, 1 to 4, or 1 to 3 carbon atoms.

As used herein, the term “amino” refers to a group of formula —NH₂.

As used herein, the term “aryl,” employed alone or in combination with other terms, refers to an aromatic hydrocarbon group, which may be monocyclic or polycyclic (e.g., having 2, 3 or 4 fused rings). The term “Cnm aryl” refers to an aryl group having from n to m ring carbon atoms. Aryl groups include, e.g., phenyl, naphthyl, anthracenyl, phenanthrenyl, indanyl, indenyl, and the like. In some embodiments, aryl groups have from 6 to about 20 carbon atoms, from 6 to about 15 carbon atoms, or from 6 to about 10 carbon atoms. In some embodiments, the aryl group is a substituted or unsubstituted phenyl.

As used herein, the term “carbamyl” to a group of formula —C(O)NH₂.

As used herein, the term “carbonyl”, employed alone or in combination with other terms, refers to a —C(═O)— group, which may also be written as C(O).

As used herein, the term “di(Cₙ₋ₘ-alkyl)amino” refers to a group of formula —N(alkyl)₂, wherein the two alkyl groups each has, independently, n to m carbon atoms. In some embodiments, each alkyl group independently has 1 to 6, 1 to 4, or 1 to 3 carbon atoms.

As used herein, the term “di(Cₙ₋ₘ-alkyl)carbamyl” refers to a group of formula —C(O)N(alkyl)₂, wherein the two alkyl groups each has, independently, n to m carbon atoms.

In some embodiments, each alkyl group independently has 1 to 6, 1 to 4, or 1 to 3 carbon atoms.

As used herein, the term “halo” refers to F, Cl, Br, or I. In some embodiments, a halo is F, Cl, or Br. In some embodiments, a halo is F or Cl.

As used herein, “Cₙ₋ₘ haloalkoxy” refers to a group of formula —O-haloalkyl having n to m carbon atoms. An example of a haloalkoxy group is OCF₃. In some embodiments, the haloalkoxy group is fluorinated only. In some embodiments, the alkyl group has 1 to 6, 1 to 4, or 1 to 3 carbon atoms.

As used herein, the term “Cₙ₋ₘ haloalkyl”, employed alone or in combination with other terms, refers to an alkyl group having from one halogen atom to 2s+1 halogen atoms which may be the same or different, where “s” is the number of carbon atoms in the alkyl group, wherein the alkyl group has n to m carbon atoms. In some embodiments, the haloalkyl group is fluorinated only. In some embodiments, the alkyl group has 1 to 6, 1 to 4, or 1 to 3 carbon atoms.

As used herein, “cycloalkyl” refers to non-aromatic cyclic hydrocarbons including cyclized alkyl and/or alkenyl groups. Cycloalkyl groups can include mono- or polycyclic (e.g., having 2, 3 or 4 fused rings) groups and spirocycles. Cycloalkyl groups can have 3, 4, 5, 6, 7, 8, 9, or 10 ring-forming carbons (C₃₋₁₀). Ring-forming carbon atoms of a cycloalkyl group can be optionally substituted by oxo or sulfido (e.g., C(O) or C(S)). Cycloalkyl groups also include cycloalkylidenes. Example cycloalkyl groups include cyclopropyl, cyclobutyl, cyclopentyl, cyclohexyl, cycloheptyl, cyclopentenyl, cyclohexenyl, cyclohexadienyl, cycloheptatrienyl, norbornyl, norpinyl, norcarnyl, and the like. In some embodiments, cycloalkyl is cyclopropyl, cyclobutyl, cyclopentyl, cyclohexyl, cyclopentyl, or adamantyl. In some embodiments, the cycloalkyl has 6-10 ring-forming carbon atoms. In some embodiments, cycloalkyl is adamantyl. Also included in the definition of cycloalkyl are moieties that have one or more aromatic rings fused (i.e., having a bond in common with) to the cycloalkyl ring, for example, benzo or thienyl derivatives of cyclopentane, cyclohexane, and the like. A cycloalkyl group containing a fused aromatic ring can be attached through any ring-forming atom including a ring-forming atom of the fused aromatic ring.

As used herein, “heteroaryl” refers to a monocyclic or polycyclic aromatic heterocycle having at least one heteroatom ring member selected from sulfur, oxygen, and nitrogen. In some embodiments, the heteroaryl ring has 1, 2, 3, or 4 heteroatom ring members independently selected from nitrogen, sulfur and oxygen. In some embodiments, any ring-forming N in a heteroaryl moiety can be an N-oxide. In some embodiments, the heteroaryl has 5-10 ring atoms and 1, 2, 3 or 4 heteroatom ring members independently selected from nitrogen, sulfur and oxygen. In some embodiments, the heteroaryl has 5-6 ring atoms and 1 or 2 heteroatom ring members independently selected from nitrogen, sulfur and oxygen. In some embodiments, the heteroaryl is a five-membered or six-membered heteroaryl ring. A five-membered heteroaryl ring is a heteroaryl with a ring having five ring atoms wherein one or more (e.g., 1, 2, or 3) ring atoms are independently selected from N, O, and S. Exemplary five-membered ring heteroaryls are thienyl, furyl, pyrrolyl, imidazolyl, thiazolyl, oxazolyl, pyrazolyl, isothiazolyl, isoxazolyl, 1,2,3-triazolyl, tetrazolyl, 1,2,3-thiadiazolyl, 1,2,3-oxadiazolyl, 1,2,4-triazolyl, 1,2,4-thiadiazolyl, 1,2,4-oxadiazolyl, 1,3,4-triazolyl, 1,3,4-thiadiazolyl, and 1,3,4-oxadiazolyl. A six-membered heteroaryl ring is a heteroaryl with a ring having six ring atoms wherein one or more (e.g., 1, 2, or 3) ring atoms are independently selected from N, O, and S. Exemplary six-membered ring heteroaryls are pyridyl, pyrazinyl, pyrimidinyl, triazinyl and pyridazinyl.

As used herein, “heterocycloalkyl” refers to non-aromatic monocyclic or polycyclic heterocycles having one or more ring-forming heteroatoms selected from O, N, or S.

Included in heterocycloalkyl are monocyclic 4-, 5-, 6-, and 7-membered heterocycloalkyl groups. Heterocycloalkyl groups can also include spirocycles. Example heterocycloalkyl groups include pyrrolidin-2-one, 1,3-isoxazolidin-2-one, pyranyl, tetrahydropuran, oxetanyl, azetidinyl, morpholino, thiomorpholino, piperazinyl, tetrahydrofuranyl, tetrahydrothienyl, piperidinyl, pyrrolidinyl, isoxazolidinyl, isothiazolidinyl, pyrazolidinyl, oxazolidinyl, thiazolidinyl, imidazolidinyl, azepanyl, benzazapene, and the like. Ring-forming carbon atoms and heteroatoms of a heterocycloalkyl group can be optionally substituted by oxo or sulfido (e.g., C(O), S(O), C(S), or S(O)₂, etc.). The heterocycloalkyl group can be attached through a ring-forming carbon atom or a ring-forming heteroatom. In some embodiments, the heterocycloalkyl group contains 0 to 3 double bonds. In some embodiments, the heterocycloalkyl group contains 0 to 2 double bonds. Also included in the definition of heterocycloalkyl are moieties that have one or more aromatic rings fused (i.e., having a bond in common with) to the cycloalkyl ring, for example, benzo or thienyl derivatives of piperidine, morpholine, azepine, etc. A heterocycloalkyl group containing a fused aromatic ring can be attached through any ring-forming atom including a ring-forming atom of the fused aromatic ring. In some embodiments, the heterocycloalkyl has 4-10, 4-7 or 4-6 ring atoms with 1 or 2 heteroatoms independently selected from nitrogen, oxygen, or sulfur and having one or more oxidized ring members.

At certain places, the definitions or embodiments refer to specific rings (e.g., an azetidine ring, a pyridine ring, etc.). Unless otherwise indicated, these rings can be attached to any ring member provided that the valency of the atom is not exceeded. For example, an azetidine ring may be attached at any position of the ring, whereas a pyridin-3-yl ring is attached at the 3-position.

The term “compound” as used herein is meant to include all stereoisomers, geometric isomers, tautomers, and isotopes of the structures depicted. Compounds herein identified by name or structure as one particular tautomeric form are intended to include other tautomeric forms unless otherwise specified.

Compounds provided herein also include tautomeric forms. Tautomeric forms result from the swapping of a single bond with an adjacent double bond together with the concomitant migration of a proton. Tautomeric forms include prototropic tautomers which are isomeric protonation states having the same empirical formula and total charge. Example prototropic tautomers include ketone—enol pairs, amide—imidic acid pairs, lactam—lactim pairs, enamine—imine pairs, and annular forms where a proton can occupy two or more positions of a heterocyclic system, for example, 1H- and 3H-imidazole, 1H-, 2H- and 4H-1,2,4-triazole, 1H- and 2H-isoindole, and 1H- and 2H-pyrazole. Tautomeric forms can be in equilibrium or sterically locked into one form by appropriate substitution.

In some embodiments, the compounds described herein can contain one or more asymmetric centers and thus occur as racemates and racemic mixtures, enantiomerically enriched mixtures, single enantiomers, individual diastereomers and diastereomeric mixtures (e.g., including (R)- and (S)-enantiomers, diastereomers, (D)-isomers, (L)-isomers, (+) (dextrorotatory) forms, (−) (levorotatory) forms, the racemic mixtures thereof, and other mixtures thereof). Additional asymmetric carbon atoms can be present in a substituent, such as an alkyl group. All such isomeric forms, as well as mixtures thereof, of these compounds are expressly included in the present description. The compounds described herein can also or further contain linkages wherein bond rotation is restricted about that particular linkage, e.g., restriction resulting from the presence of a ring or double bond (e.g., carbon-carbon bonds, carbon-nitrogen bonds such as amide bonds). Accordingly, all cis/trans and E/Z isomers and rotational isomers are expressly included in the present description. Unless otherwise mentioned or indicated, the chemical designation of a compound encompasses the mixture of all possible stereochemically isomeric forms of that compound.

Optical isomers can be obtained in pure form by standard procedures known to those skilled in the art, and include, but are not limited to, diastereomeric salt formation, kinetic resolution, and asymmetric synthesis. See, for example, Jacques, et al., Enantiomers, Racemates and Resolutions (Wiley Interscience, New York, 1981); Wilen, S. H., et al., Tetrahedron 33:2725 (1977); Eliel, E. L. Stereochemistry of Carbon Compounds (McGraw-Hill, NY, 1962); Wilen, S. H. Tables of Resolving Agents and Optical Resolutions p. 268 (E. L. Eliel, Ed., Univ. of Notre Dame Press, Notre Dame, IN 1972), each of which is incorporated herein by reference in their entireties. It is also understood that the compounds described herein include all possible regioisomers, and mixtures thereof, which can be obtained in pure form by standard separation procedures known to those skilled in the art, and include, but are not limited to, column chromatography, thin-layer chromatography, and high-performance liquid chromatography.

A “solvent” as described herein can include water or an organic solvent. Examples of organic solvents include hydrocarbons such as toluene, xylene, hexane, and heptane; chlorinated solvents such as methylene chloride, chloroform, and dichloroethane; ethers such as diethyl ether, tetrahydrofuran, and dibutyl ether; ketones such as acetone and 2-butanone; esters such as ethyl acetate and butyl acetate; nitriles such as acetonitrile; alcohols such as methanol, ethanol, and tert-butanol; and aprotic polar solvents such as N,N-dimethylformamide (DMF), N,N-dimethylacetamide (DMA), and dimethyl sulfoxide (DMSO). Solvents may be used alone or two or more of them may be mixed for use to provide a “solvent system”.

A non-polar solvent is a liquid or solvent that has a low or non-existing dipole moment and is missing any partial positive or negative charges. Generally, it has small differences in electronegativity between atoms in the solvent molecule and has a low dielectric constant. A non-polar solvents cannot effectively dissolve a polar compound. Examples of a non-polar solvent includes alkanes, toluene, chloroform and diethyl ether.

The term, “repeat unit”, “repeating unit”, or “block” as used herein refers to the moiety of a polymer that is repetitive. The repeat unit may comprise one or more repeat units, labeled as, for example, repeat unit A, repeat unit B, repeat unit C, etc. Repeat units A-C, for example, may be covalently bound together to form a combined repeat unit. Monomers or a combination of one or more different monomers can be combined to form a (combined) repeat unit of a polymer or copolymer.

The term “molecular weight” for the copolymers disclosed herein refers to the average number molecular weight (Mn). The corresponding weight average molecular weight (Mw) can be determined from other disclosed parameters by methods (e.g., by calculation) known to the skilled artisan.

### Methods of Post-Polymerization Modification

Provided herein are methods for the post-polymerization modification of (co)polymers comprising a monomer repeat unit comprising a pendant secondary or tertiary amide moiety (e.g., (meth)acrylamide copolymers). Such methods can covalently functionalize one or more of the monomer repeat units along the backbone of the (co)polymer, introducing new functionality into the (co)polymer.

By way of example, many commercial synthetic polymers do not have accessible degradation pathways and therefore become large contributors to landfill waste and environmental pollution. A significant research thrust in polymer chemistry focuses on reducing this waste by developing new catalysts or methods to degrade these polymers. However, these generally have not yet been shown to be effective on larger (commercial) scales.

An alternative approach focuses on the design and synthesis of new degradable polymers. The degradable polymers, however, typically require specific functional groups, which may have detrimental effects on desired material properties as the functional groups are directly linked to the physical properties of polymers. There is an outstanding challenge to develop methods that lead to degradable polymers which also exhibit the desired physical properties.

(Co)polymers comprising different functional groups can achieve this goal, but many types of functional groups are not compatible with conventional polymerization methods. Thus, it is not possible to prepare all types of copolymers simply through using conventional polymerization. Alternatively, further functionality can be incorporated into a polymer through post-polymerization modification (PPM). However, current PPM methods typically require specialty monomers, which, upon polymerization, form activated homopolymers that are designed to undergo further reactivity but have no other utility.

Instead, herein we focus on the development of a new PPM method that utilizes the innate functionality (i.e., an amide group) of a common synthetic polymer (poly(meth)acrylamides) to prepare degradable, functional copolymers comprised of (meth)acrylamide and vinyl ketone repeat units.

For example, described herein are post-polymerization modification methods that can convert secondary and tertiary (meth)acrylamide homopolymers and copolymers into unprecedented copolymers bearing both a randomly distributed ketone functionality and the original amide functionality. The method can allow the new ketone functionality to be randomly distributed along the polymer backbone, which cannot be achieved using conventional polymerization methods. The method also enables tunable degrees of functionalization, ranging from greater than 0 mol % up to 30 mol % ketone functionality (e.g., from 1 mol % to up to 30 mol % ketone functionality), and is compatible with various functional groups (e.g., alkyl, aryl, unsaturated, amine, etc.) of the ketone moiety.

In some cases, the ketone functionality of the copolymers also renders the copolymers degradable under UV irradiation, which was previously not possible for poly(meth)acrylamide materials. The method successfully functionalizes poly(meth)acrylamides of various molecular weight and therefore can be employed to produce copolymers for a variety of applications. For example, the resultant copolymers can be used in applications ranging from degradable drug delivery vehicles to adhesives, flocculants, and polymer coatings.

Accordingly, provided herein are methods for the post-polymerization modification of a (co)polymer comprising a monomer repeat unit comprising a pendant secondary or tertiary amide moiety. These methods can comprise activating the pendant secondary or tertiary amide moiety to form a keteniminium ion (in the case of a tertiary amide) or a nitrilium ion (in the case of a secondary amide); and quenching the keteniminium ion or the nitrilium ion with a nucleophile to covalently functionalize the monomer repeat unit.

The (co)polymer (polymer or copolymer) can comprise an polymer bearing a pendant secondary or tertiary amide moiety on sidechains present along the (co)polymer backbone, provided that the polymer does not otherwise include a functional group that is incompatible with the post-polymerization modification strategies described herein. In certain embodiments, the (co)polymer can comprise a (meth)acrylamide (co)polymer (i.e., an acrylamide homopolymer, an acrylamide copolymer, a nethacrylamide homopolymer, or a methacrylamide copolymer).

(Meth)acrylamide (co)polymers include polymers and copolymers that are formed from the polymerization of one or more distinct monomers, at least one of which possesses an (meth)acrylamide functional group (i.e., an acrylamide monomer or a methacrylamide monomer). In some embodiments, the (meth)acrylamide (co)polymer can comprise a (meth)acrylamide homopolymer (i.e., an acrylamide homopolymer or a methacrylamide homopolymer) or a (meth)acrylamide copolymer (i.e., an acrylamide copolymer or a methacrylamide copolymer). In the case of copolymers, these copolymers can comprise alternating copolymers wherein the monomer species are connected in an alternating fashion; random copolymers wherein the monomer species are connected to each other within a polymer chain without a defined pattern; block copolymers wherein polymeric blocks of one monomer species are connected to polymeric blocks made up of another monomer species; and graft copolymers wherein the main polymer chain consists of one monomer species, and polymeric blocks of another monomer species are connected to the main polymer chain as side branches (also referred to as sidechains). In some embodiments, the (meth)acrylamide copolymer can comprise a random copolymer.

In some embodiments, the (meth)acrylamide (co)polymer can comprise a copolymer formed from the polymerization of two structurally different (meth)acrylamide monomers (two structurally different monomers that each possess a (meth)acrylamide functional group). (Meth)acrylamide monomers include monomer species that possesses a (meth)acrylamide functional group (including not only monomeric (meth)acrylamide, but derivatives of monomeric (meth)acrylamide as well). Examples of (meth)acrylamide monomers include, for example, acrylamide, methacrylamide, N-methylacrylamide, N-methylmethacrylamide, N-ethylacrylamide, N-ethylmethacrylamide, N-butylacrylamide, N-butylmethacrylamide, N,N-dimethylacrylamide, N,N-dimethylmethacrylamide, N-(3-methoxypropoyl)acrylamide (MPAM), 4-acryloylmorpholine (MORPH), N,N-dimethylacrylamide (DMA), N-hydroxyethyl acrylamide (HEAM), N-[tris(hydroxymethyl)-methyl]acrylamide (TRI), 2-acrylamido-2-methylpropane sulfonic acid (AMP), (3-acrylamidopropyl)trimethylammonium chloride (TMA), N-isopropyl acrylamide (NIP), N,N-diethylacrylamide (DEA), N-tert-butyl acrylamide (TBA), N-[3-(dimethylamino)propyl]acrylamide, and N-phenyl acrylamide (PHE).

In some embodiments, the monomer repeat unit comprising the pendant secondary or tertiary amide moiety can be defined by the structure below

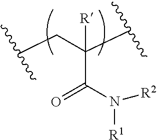

wherein R¹ and R² are individually hydrogen or substituted or unsubstituted C1-C12 alkyl, C2-C12 alkenyl, C2-C12 alkynyl, cycloalkyl, heterocycloalkyl, aryl, or heteroaryl, or R¹ and R² together with the atom to which they are attached form a substituted or unsubstituted cycloalkyl or heterocycloalkyl ring, with the proviso that only one of R¹ and R² can be hydrogen; and R′ is hydrogen or methyl.

In some embodiments, activating the secondary or tertiary amide moiety comprises contacting the secondary or tertiary amide moiety with a strong electrophile, such as trifluoromethanesulfonic anhydride (Tf₂O), N-Phenyl(trifluoromethane)sulfonamide, N,N-Bis(trifluoromethylsulfonyl)aniline, 4-Nitrophenyl Trifluoromethanesulfonate, N-(5-Chloro-2-pyridyl)bis(trifluoromethanesulfonyl)imide, 1-(Trifluoromethanesulfonyl)imidazole, or 1-(Trifluoromethanesulfonyl)-1H-benzotriazole.

In some embodiments, the secondary or tertiary amide moiety is contacted with the strong electrophile in the presence of a non-nucleophilic base, such as a nitrogenous base. In some embodiments, the nitrogenous base comprises a pyridyl base. The pyridyl base can comprise pyridine or a substituted pyridine. Examples of pyridyl bases include, but are not limited to, pyridine, 2-fluoropyridine, 2-bromopyridine, 2-iodopyridine, 2-chloropyridine 2,4,6-trimethylpyridine, 2,6-di-tert-butyl-4-methylpyridine, 2-fluoro-5-iodopyridine, 2-chloro-6-fluoropyridine, pentafluoropyridine, 2,6-difluoropyridine, or 2-fluoro-6-methylpyridine. In some embodiments, the pyridyl bases can comprise a pyridine substituted with one or more electron withdrawing groups, such as one or more halogens. In some embodiments, the pyridyl bases can comprise a pyridine substituted with one or more C1-C4 alkyl groups.

In some embodiments, the nucleophile comprises a Grignard reagent. Examples of Grignard reagents include, but are not limited to, organicmagnesium halides such as organomagesium chlorides and organomagnesium bromides. Non-limiting examples of Grignard reagents include methylmagnesium (chloride or bromide), substituted methylmagensium (chlorides or bromides) such as 2-naphthylenylmethylmagensium (chloride or bromide), cyclohexylmethylmagensium (chloride or bromide), and 1,3-dioxanylmethyl magnesium (chloride or bromide), ethyl magnesium (chloride or bromide), phenylmagnesium (chloride or bromide), substituted phenylmagnesium (chlorides or bromides), and others known in the art. In some embodiments, the nucleophile can comprise a Grignard reagent defined by R^{B}—MgX, where X is a halide (e.g., Cl or Br) and R^{B} is substituted or unsubstituted alkyl, alkenyl, alkynyl, cycloalkyl, heterocycloalkyl, aryl, or heteroaryl. In certain embodiments, the nucleophile comprises a Grignard reagent, such as a Grignard reagent defined by R^{B}—MgX, where X is a halide (e.g., Cl or Br) and R^{B} is substituted or unsubstituted aryl or heteroaryl. Other suitable nucleophiles can include, for example, azides and ethylenically unsaturated groups (e.g., alkenes, enolate nucleophiles, and alkynes).

In some embodiments, following quenching of the keteniminium ion or the nitrilium ion with the nucleophile to covalently functionalize the monomer repeat unit, the monomer repeat unit is defined by the structure below

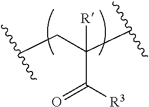

wherein R³ is a substituted or unsubstituted alkyl, alkenyl, alkynyl, cycloalkyl, heterocycloalkyl, aryl, or heteroaryl group; and R′ is hydrogen or methyl. In some embodiments, R³ is a substituted or unsubstituted aryl or heteroaryl group. In certain embodiments, R³ is a substituted or unsubstituted aryl group.

In some embodiments, upon covalently functionalization of the monomer repeat unit, the polymer is UV degradable. For example, in some embodiments, upon covalent functionalization of the monomer repeat unit, the monomer repeat unit can undergo a Norrish type 2 radical fragmentation under UV irradiation, thereby cleaving the (co)polymer backbone.

Importantly, the degree of post-polymerization modification along the (co)polymer backbone can be varied so as to alter the properties of the copolymer following post-polymerization modification. By way of example, in the case of aryl ketone moieties introduced along the polymer backbone to provide UV degradability to the polymer, degradability (including degradation rate, molecular weight of the degraded oligomers, etc.) can be altered by incorporating varying amounts of the aryl ketone moiety along the backbone.

In some embodiments, from greater than 0 mol % up to 30 mol % (e.g., from greater than 0 mol % up to 25 mol %, from greater than 0 mol % up to 20 mol %, from greater than 0 mol % up to 15 mol %, from greater than 0 mol % up to 10 mol %, from greater than 0 mol % up to 5 mol %, from 1 mol % to up to 30 mol %, from 1 mol % to up to 25 mol %, from 1 mol % to up to 20 mol %, from 1 mol % to up to 15 mol %, from 1 mol % to up to 10 mol %, or from 1 mol % to up to 5 mol %) of the monomer repeat units comprising the pendant secondary or tertiary amide moiety in the (co)polymer are covalently functionalized using the post-polymerization modification methodologies described herein.

Also provided herein are random copolymers that can be prepared using the post-polymerization modification strategies described herein. In many cases, these random copolymers were previously inaccessible via traditional polymerization methodologies (e.g., due to incompatibility of the requisite monomers with the polymerization process). For example, provided herein are random copolymers composed of (meth)acrylamide and (methyl)vinyl ketone repeat units.

In some embodiments, the random copolymer can be defined by the formula below

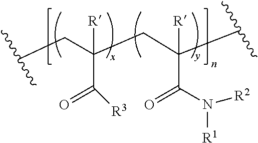

wherein R¹ and R² are individually hydrogen or substituted or unsubstituted C1-C12 alkyl, C2-C12 alkenyl, C2-C12 alkynyl, cycloalkyl, heterocycloalkyl, aryl, or heteroaryl, or R¹ and R² together with the atom to which they are attached form a substituted or unsubstituted cycloalkyl or heterocycloalkyl ring, with the proviso that only one of R¹ and R² can be hydrogen; R³ is a substituted or unsubstituted alkyl, alkenyl, alkynyl, cycloalkyl, heterocycloalkyl, aryl, or heteroaryl group; R′ is hydrogen or methyl; x is an integer from 1 to 25,000; y is an integer from 1 to 500,000; and n is an integer from 2 to 525,000.

In some embodiments, R³ is a substituted or unsubstituted aryl or heteroaryl group. In certain embodiments, R³ is a substituted or unsubstituted aryl group.

In some embodiments, the random copolymer is UV degradable.

Also provided herein are methods of producing UV degradable (meth)acrylamide copolymers. These methods can comprise activating a pendant secondary or tertiary amide moiety present in a (meth)acrylamide (co)polymer to form a keteniminium ion or a nitrilium ion; and quenching the keteniminium ion or the nitrilium ion with a nucleophile to form a monomer repeat unit is defined by the structure below

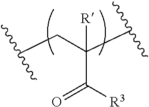

wherein R³ is a substituted or unsubstituted aryl group; and R′ is hydrogen or methyl.

In some embodiments, upon UV irradiation, the UV degradable (meth)acrylamide copolymer can undergo a Norrish type 2 radical fragmentation.

As discussed above, UV degradable poly(meth)acrylamide materials are not currently available in the art. The methods described herein provide access to poly(meth)acrylamide copolymers with tunable degradation behavior. Further, the method successfully functionalizes poly(meth)acrylamides of various molecular weight and therefore can be employed to produce copolymers for a variety of applications. For example, the resultant copolymers can be used in applications ranging from degradable drug delivery vehicles to adhesives, flocculants, and polymer coatings.

Accordingly, provided herein are methods for delivering an active agent (e.g., a therapeutic agent, a diagnostic agent, a prophylactic agent, a agrochemical compound, an insecticide, an herbicide, an odorant, a colorant or dye, a surfactant, etc.) to a target that comprise contacting the target (or an area in proximity to the target) with a composition comprising the active agent dispersed in a polymeric matrix comprising a random copolymer defined by the formula below

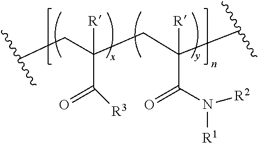

wherein R¹ and R² are individually hydrogen or substituted or unsubstituted C1-C12 alkyl, C2-C12 alkenyl, C2-C12 alkynyl, cycloalkyl, heterocycloalkyl, aryl, or heteroaryl, or R¹ and R² together with the atom to which they are attached form a substituted or unsubstituted cycloalkyl or heterocycloalkyl ring, with the proviso that only one of R¹ and R² can be hydrogen; R³ is a substituted or unsubstituted aryl or heteroaryl group; R′ is hydrogen or methyl; x is an integer from 1 to 25,000; y is an integer from 1 to 500,000; and n is an integer from 2 to 525,000; and irradiating the composition with UV light. UV light can trigger degradation of the polymeric matrix, releasing the active agent in proximity to the target.

In other examples, the polymer can comprise an adhesive composition. UV light can trigger degradation of the adhesive composition, releasing an article adhered using the adhesive. This triggered release can be useful, for example, in the context of recycling applications. For example, the degradable poly(meth)acrylamide adhesive can be used to adhere labels to recyclable containers. Upon collection, UV irradiation can trigger degradation of the adhesive, releasing the labels from the recyclable containers. The containers (with labels removed) can then be recycled using conventional methods.

By way of non-limiting illustration, examples of certain embodiments of the present disclosure are given below.

### EXAMPLES

Post-polymerization modification (PPM), or the alteration of molecular structure in a subsequent synthetic step, represents a complementary approach to the preparation of functional materials. PPM strategies have been widely utilized to prepare (co)polymers that are otherwise difficult or impossible to obtain, but typically require the preparation of activated polymer precursors containing synthetic handles that are designed to undergo derivatization. PPM strategies for acryloyl-based polymers that utilize the innate functionality of a non-activated polymer substrate are comparatively rare and limited to select functional groups. The required highly-engineered (co)monomers have led to a library of broadly functional polymers, yet do not overcome the aforementioned compatibility limitations.

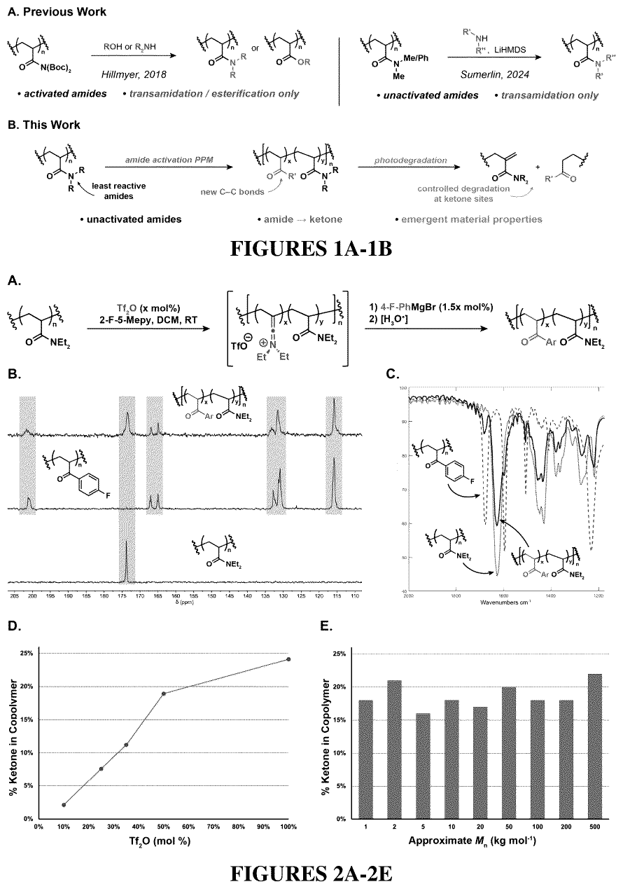

Poly(acrylamide)s represent an underexplored class of synthetic polymers for PPM, despite the fact that the relatively limited chemical diversity found in acrylamide monomers suggests a high value target. Typical poly(acrylamide) PPM strategies (FIG. 1A) rely on sacrificial synthetic handles (i.e., á la polymeric activated esters) or highly-specialized reactivity that is limited in scope (e.g., Kabacknik-Fields reactions). PPM approaches that take advantage of the pendant amide functionality in poly(acrylamide)s are exceedingly rare, with only a single recent disclosure that achieved transamidation using strong lithium amide nucleophiles. A new approach to PPM that enables straightforward functionalization of unactivated polyacrylamides would unlock libraries of well-defined functional materials with enhanced, or in some cases entirely new, properties from this important class of polymers.

Amide activation strategies have emerged as powerful, selective methodologies for the transformation of amide functional groups in small-molecule organic chemistry. Despite being historically poor C-electrophiles, the relatively high O-nucleophilicity of amides can be utilized to access reactive ion intermediates that are susceptible to quenching from a variety of common nucleophiles. In particular, keteniminium ions have shown to be robust reaction partners that can be generated under relatively mild conditions from N,N-dialkylamides, the least reactive amide groups. We hypothesized the unique reactivity of keteniminium intermediates, generated directly from unactivated tertiary amide pendant groups, would enable facile conversion of a desired quantity of amides to ketones. Repeat units formally derived from vinyl ketones are expected to be randomly incorporated throughout the polymer chain due to the stochastic nature of PPM, overcoming the reactivity mismatch that would plague a statistical copolymerization approach and facilitating the library synthesis of new synthetic copolymers. Ultimately, we envisioned the incorporation of aryl ketones, specifically, would enable the controlled photodegradation of otherwise non-degradable synthetic polyacrylamides, highlighting the power of this amide activation approach for accessing emergent material properties (FIG. 1B).

We identified poly(diethylacrylamide) (polyDEAm) as an ideal, unactivated substrate for exploring amide activation PPM due to solubility in a wide range of organic solvents and ease of characterization. Leveraging established controlled radical polymerization techniques (i.e., Reversible Addition-Fragmentation chain Transfer (RAFT) polymerization) furnished well-defined (Ð<1.15) polyDEAm in a variety of molecular weights (Mₙ=1-500 kg mol⁻¹).

In an initial screen, polyDEAm (Mₙ=10 kg mol⁻¹) was exposed to trifluoromethanesulfonic anhydride (Tf₂O) in the presence of di-tert-butylmethylpyridine (DTBMP) at −78° C., which was accompanied by an obvious color change from colorless/pale yellow to deep orange. Nucleophilic quenching of the putative keteniminium ion intermediate using 4-fluorophenylmagnesium bromide resulted in an immediate color change to yellow, and was followed by an acidic hydrolysis step (FIG. 2A).

¹H NMR analysis of the resulting materials revealed new resonances in the aromatic region (δ 7.1 ppm and 8.0 ppm). Likewise, aromatic resonances were observed by ¹³C NMR (δ 113-167 ppm) along with the appearance of a new resonance at δ 202 ppm, indicative of an aryl ketone. An intense resonance at δ 105 ppm in the ¹⁹F NMR was also consistent with the formation of a 4-fluorophenyl ketone. In addition, ¹³C and ¹⁹F NMR analysis of a poly(vinyl 4-fluorophenyl ketone) (polyFVK) homopolymer sample, prepared in our lab using RAFT, revealed nearly identical resonances to those now observed after PPM (FIG. 2B). Similarly, the appearance of carbonyl IR stretching frequencies at 1600 and 1700 cm⁻¹ after functionalization aligned perfectly with those observed in the native polyFVK sample (FIG. 2C). Collectively, these data support a copolymer structure comprised of pendant diethylamides, unchanged from the starting polyDEAm, and 4-fluorophenylketones, achieved through PPM.

Interestingly, two distinct resonances were observed in the ¹⁹F NMR spectrum which indicated a small percentage of repeat units undergo two nucleophile additions to form highly functional tertiary amine repeat units. Isolation and characterization of analogous small molecule models revealed a nearly identical ¹⁹F resonance (δ-115 ppm), confirming the assignment as a tertiary amine. Though formally arising from an addition polymerization of substituted allyl amines, and not the focus of this work, it would be difficult to imagine preparing polymers with this molecular structure through homopolymerization.

Upon confirming molecular structure, we sought to optimize the reaction to maximize conversion to ketone, minimize conversion to tertiary amine, and maximize overall yield. It was immediately obvious upon screening conditions that the Brønsted base was a non-innocent reaction partner, as reaction mixtures exhibited substantial color changes during base screening. Indeed, the identity of the pyridine base (i.e., 2-fluoro-5-methylpyridine) was an important reaction parameter that was optimized to achieve up to 22% ketone repeat units (overall polymer structure) with a target functionalization of 50 mol %. Significantly, quenching keteniminium ion intermediates derived from polyDEAm with acid directly (i.e., no addition of exogenous nucleophile) resulted in clean reversion to polyDEAm with no observed degradation by NMR or gel-permeation chromatography (GPC). Tunable functionalization was achieved by altering the initial stoichiometry of Tf₂O (FIG. 2D) and functionalization efficiency was not impacted by molecular weight, with polyDEA up to nearly 500 kg mol⁻¹ amenable to the standard reaction conditions. In addition, despite clear literature precedent for the necessity of cryogenic temperatures (i.e., −78° C.), no degradation in functionalization efficiency or yield was observed when operating entirely at room temperature.

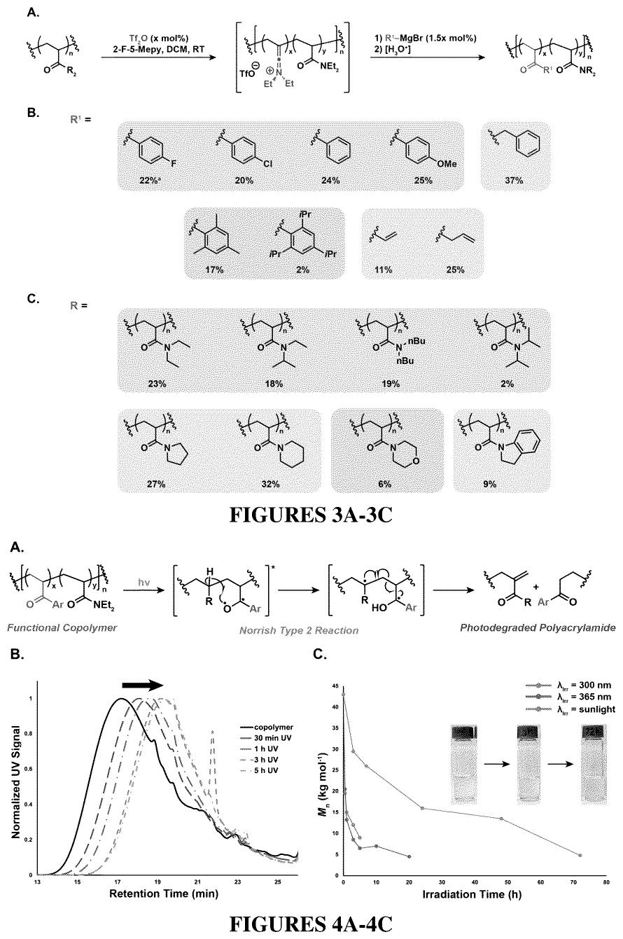

The wide availability of commercial Grignard reagents coupled with the synthetic accessibility of non-commercial Grignard reagents renders them an ideal nucleophile class for polymer functionalization. Poly(DEAm-co-vinyl ketone) materials comprised of a wide array of functionality were prepared using our amide activation PPM approach, including various aryl (electron rich and poor), alkyl, sterically hindered, and unsaturated groups. The vinyl- and allyl-containing materials are particularly interesting as they contain functionality that could be exploited for further derivatization if desired (FIG. 3B). In addition, a variety of unactivated polyacrylamides were shown to undergo functionalization, including those with non-symmetrical substitution, sterically hindered, and cyclic amides as pendant groups (FIG. 3C).

The propensity for aryl ketones to undergo Norrish type 2 radical fragmentation under UV irradiation led us to the hypothesis that our functionalization approach could be harnessed to achieve the tunable UV degradation of non-degradable poly(dialkylacrylamides) (FIG. 4A). In a preliminary experiment, a sample of poly(DEAm-co-4-fluorophenylvinyl ketone) with 18% ketone repeat units prepared through amide activation PPM of polyDEAm was subjected to UV radiation (\tilde{λ}=300 nm) for 30 min. A color change from pale yellow to colorless was observed, and GPC analysis revealed an obvious shift to longer retention times (FIG. 4B). The polyDEAm sample (Mₙ=43 kg mol⁻¹) was significantly degraded (Mₙ=8 kg mol⁻¹) after functionalization and UV irradiation, roughly to the size expected if the 18% ketone repeat units were randomly distributed throughout the polymer chain. We have further shown that lower intensity UV radiation is competent for degradation, including a 50 W UV lamp (\tilde{λ}=365 nm) and Lawrence, KS sunlight (broad spectrum), which took roughly 5 h and 72 h to reach maximum degradation, respectively. (FIG. 4C).

In summary, we have demonstrated a new PPM approach for the functionalization of unactivated polyacrylamides by leveraging the unique reactivity of keteniminum ions. Our methodology avoids the use of designer monomers or activated polymer precursors and expands beyond transamidation, allowing us to prepare a series of functional copolymers comprised of acrylamide and vinyl ketone repeat units from easily accessible, stable polyacrylamides. Through judicious choice of reaction conditions, both the molecular structure and relative composition of the resulting copolymers can be modulated. A variety of unactivated poly(dialkylacrylamide) precursors were tolerated, and the method was shown to be amenable to aryl, alkyl, and unsaturated nucleophiles. Furthermore, the resulting materials were susceptible to photodegradation under UV irradiation, including broad spectrum sunlight, a marked change from the non-degradable parent materials. The ability to harness keteniminium ions for polymer functionalization demonstrates the potential for utilizing reactive intermediates in PPM, while the observed degradation behavior further highlights the emergent properties that can be found through the synthesis of polymers with novel molecular structures.

### REFERENCES

(1) Chen, E. Y. X. Coordination Polymerization of Polar Vinyl Monomers by Single-Site Metal Catalysts. Chem. Rev. 2009, 109 (11), 5157-5214.
(2) Perrier, S. 50th Anniversary Perspective: RAFT Polymerization—A User Guide. Macromolecules 2017, 50 (19), 7433-7447.
(3) Matyjaszewski, K. Atom Transfer Radical Polymerization (ATRP): Current Status and Future Perspectives. Macromolecules 2012, 45 (10), 4015-4039.
(4) Ribelli, T. G.; Lorandi, F.; Fantin, M.; Matyjaszewski, K. Atom Transfer Radical Polymerization: Billion Times More Active Catalysts and New Initiation Systems. Macromol. Rapid Commun. 2019, 40 (1), 1800616.
(5) Hill, M. R.; Carmean, R. N.; Sumerlin, B. S. Expanding the Scope of RAFT Polymerization: Recent Advances and New Horizons. Macromolecules 2015, 48 (16), 5459-5469.
(6) Roth, P. J.; Wiss, K. T.; Theato, P. 5.12—Post-Polymerization Modification. In Polymer Science: A Comprehensive Reference; Matyjaszewski, K., MOller, M., Eds.; Elsevier: Amsterdam, 2012; pp 247-267.
(7) Blasco, E.; Sims, M. B.; Goldmann, A. S.; Sumerlin, B. S.; Barner-Kowollik, C. 50th Anniversary Perspective: Polymer Functionalization. Macromolecules 2017, 50 (14), 5215-5252.
(8) Kubo, T.; Figg, C. A.; Swartz, J. L.; Brooks, W. L. A.; Sumerlin, B. S. Multifunctional Homopolymers: Postpolymerization Modification via Sequential Nucleophilic Aromatic Substitution. Macromolecules 2016, 49 (6), 2077-2084.
(9) Gauthier, M. A.; Gibson, M. I.; Klok, H. A. Synthesis of Functional Polymers by Post-Polymerization Modification. Angew. Chem. Int. Ed. 2009, 48 (1), 48-58.
(10) Larsen, M. B.; Herzog, S. E.; Quilter, H. C.; Hillmyer, M. A. Activated Polyacrylamides as Versatile Substrates for Postpolymerization Modification. ACS Macro Lett. 2018, 7 (1), 122-126.
(11) Bachler, P. R.; Schulz, M. D.; Sparks, C. A.; Wagener, K. B.; Sumerlin, B. S. Aminobisphosphonate Polymers via RAFT and a Multicomponent Kabachnik-Fields Reaction. Macromol. Rapid Commun. 2015, 36 (9), 828-833.
(12) Madelaine, C.; Valerio, V.; Maulide, N. Revisiting Keteniminium Salts: More than the Nitrogen Analogs of Ketenes. Chem.—Asian J. 2011, 6 (9), 2224-2239.
(13) Kaiser, D.; Bauer, A.; Lemmerer, M.; Maulide, N. Amide Activation: An Emerging Tool for Chemoselective Synthesis. Chem. Soc. Rev. 2018, 47 (21), 7899-7925.
(14) Kumagai, N.; Shibasaki, M. Nucleophilic and Electrophilic Activation of Non-Heteroaromatic Amides in Atom-Economical Asymmetric Catalysis. Chem.—Eur. J. 2016, 22 (43), 15192-15200.
(15) Kemnitz, C. R.; Loewen, M. J. “Amide Resonance” Correlates with a Breadth of C-N Rotation Barriers. J. Am. Chem. Soc. 2007, 129 (9), 2521-2528.
(16) Mucsi, Z.; Tsai, A.; Szori, M.; Chass, G. A.; Viskolcz, B.; Csizmadia, I. G. A Quantitative Scale for the Extent of Conjugation of the Amide Bond. Amidity Percentage as a Chemical Driving Force. J. Phys. Chem. A 2007, 111 (50), 13245-13254.
(17) Yamashita, N.; Kazuyukiikezawa; Ayukawa, S. I.; Maeshima, T. Radical Copolymerizability of Acrylamide Derivatives with Methyl Vinyl Ketone. J. Macromol. Sci. Part—Chem. 1984, 21 (5), 615-629.

The compositions, systems, and methods of the appended claims are not limited in scope by the specific compositions, systems, and methods described herein, which are intended as illustrations of a few aspects of the claims. Any compositions, systems, and methods that are functionally equivalent are intended to fall within the scope of the claims. Various modifications of the compositions, systems, and methods in addition to those shown and described herein are intended to fall within the scope of the appended claims. Further, while only certain representative compositions, systems, and method steps disclosed herein are specifically described, other combinations of the compositions, systems, and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments of the invention and are also disclosed. Other than where noted, all numbers expressing geometries, dimensions, and so forth used in the specification and claims are to be understood at the very least, and not as an attempt to limit the application of the doctrine of equivalents to the scope of the claims, to be construed in light of the number of significant digits and ordinary rounding approaches.

Unless defined otherwise, all technical and scientific terms used herein have the same meanings as commonly understood by one of skill in the art to which the disclosed invention belongs. Publications cited herein and the materials for which they are cited are specifically incorporated by reference.

What is claimed is:

1. A method for post-polymerization modification of a (co)polymer comprising a monomer repeat unit comprising a pendant secondary or tertiary amide moiety, the method comprising:
activating the pendant tertiary amide moiety to form a keteniminium ion or a nitrilium ion; and
quenching the keteniminium ion or a nitrilium ion with a nucleophile to covalently functionalize the monomer repeat unit.

2. The method of claim 1, wherein the (co)polymer comprises a (meth)acrylamide (co)polymer.

3. The method of claim 1, wherein the monomer repeat unit comprising the pendant secondary or tertiary amide moiety is defined by the structure below 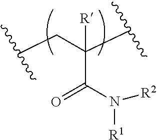
wherein
R¹ and R² are individually hydrogen or substituted or unsubstituted C1-C12 alkyl, C2-C12 alkenyl, C2-C12 alkynyl, cycloalkyl, heterocycloalkyl, aryl, or heteroaryl, or R¹ and R² together with the atom to which they are attached form a substituted or unsubstituted cycloalkyl or heterocycloalkyl ring, with the proviso that only one of R¹ and R² can be hydrogen; and
R′ is hydrogen or methyl.

4. The method of claim 1, wherein the monomer repeat unit is derived from polymerization of a (meth)acrylamide monomer chosen from acrylamide, methacrylamide, N-methylacrylamide, N-methylmethacrylamide, N-ethylacrylamide, N-ethylmethacrylamide, N-butylacrylamide, N-butylmethacrylamide, N,N-dimethylacrylamide, N,N-dimethylmethacrylamide, N-(3-methoxypropoyl)acrylamide (MPAM), 4-acryloylmorpholine (MORPH), N,N-dimethylacrylamide (DMA), N-hydroxyethyl acrylamide (HEAM), N-[tris(hydroxymethyl)-methyl]acrylamide (TRI), 2-acrylamido-2-methylpropane sulfonic acid (AMP), (3-acrylamidopropyl)trimethylammonium chloride (TMA), N-isopropyl acrylamide (NIP), N,N-diethylacrylamide (DEA), N-tert-butyl acrylamide (TBA), N-[3-(dimethylamino)propyl]acrylamide, and N-phenyl acrylamide (PHE).

5. The method of claim 1, wherein activating the secondary or tertiary amide moiety comprises contacting the secondary or tertiary amide moiety with a strong electrophile, such as trifluoromethanesulfonic anhydride (Tf₂O), N-Phenyl(trifluoromethane)sulfonamide, N,N-Bis(trifluoromethylsulfonyl)aniline, 4-Nitrophenyl Trifluoromethanesulfonate, N-(5-Chloro-2-pyridyl)bis(trifluoromethanesulfonyl)imide, 1-(Trifluoromethanesulfonyl)imidazole, or 1-(Trifluoromethanesulfonyl)-1H-benzotriazole.

6. The method of claim 5, wherein the secondary or tertiary amide moiety is contacted with the strong electrophile in the presence of non-nucleophilic base, such as a nitrogenous base.

7. The method of claim 6, wherein the nitrogenous base comprises a pyridyl base, such as a pyridyl base, such as pyridine, 2-fluoropyridine, 2-bromopyridine, 2-iodopyridine, 2-chloropyridine 2,4,6-trimethylpyridine, 2,6-di-tert-butyl-4-methylpyridine, 2-fluoro-5-iodopyridine, 2-chloro-6-fluoropyridine, pentafluoropyridine, 2,6-difluoropyridine, or 2-fluoro-6-methylpyridine.

8. The method of claim 1, wherein the nucleophile comprises a Grignard reagent, such as a Grignard reagent defined by R^{B}—MgX, where X is a halide (e.g., Cl or Br) and R^{B} is substituted or unsubstituted alkyl, alkenyl, alkynyl, cycloalkyl, heterocycloalkyl, aryl, or heteroaryl.

9. The method of claim 8, wherein the nucleophile comprises a Grignard reagent, such as a Grignard reagent defined by R^{B}—MgX, where X is a halide (e.g., Cl or Br) and R^{B} is substituted or unsubstituted aryl or heteroaryl.

10. The method of claim 1, wherein following quenching of the keteniminium ion or the nitrilium ion with the nucleophile to covalently functionalize the monomer repeat unit, the monomer repeat unit is defined by the structure below 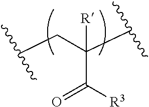
wherein
R³ is a substituted or unsubstituted alkyl, alkenyl, alkynyl, cycloalkyl, heterocycloalkyl, aryl, or heteroaryl group; and
R′ is hydrogen or methyl.

11. The method of claim 10, wherein R³ is a substituted or unsubstituted aryl or heteroaryl group.

12. The method of claim 1, wherein upon covalently functionalization of the monomer repeat unit, the polymer is UV degradable.

13. The method of claim 12, wherein upon covalent functionalization of the monomer repeat unit, the monomer repeat unit can undergo a Norrish type 2 radical fragmentation under UV irradiation, thereby cleaving the (co)polymer backbone.

14. The method of claim 1, wherein from 1 mol % to 30 mol % of the monomer repeat units comprising the pendant secondary or tertiary amide moiety in the (co)polymer are covalently functionalized.

15. The method of claim 1, wherein following quenching of the keteniminium ion or the nitrilium ion with the nucleophile to covalently functionalize the monomer repeat unit, the (co)polymer comprises a random copolymer defined by the formula below 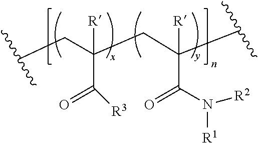
wherein
R¹ and R² are individually hydrogen or substituted or unsubstituted C1-C12 alkyl, C2-C12 alkenyl, C2-C12 alkynyl, cycloalkyl, heterocycloalkyl, aryl, or heteroaryl, or R¹ and R² together with the atom to which they are attached form a substituted or unsubstituted cycloalkyl or heterocycloalkyl ring, with the proviso that only one of R¹ and R² can be hydrogen;
R³ is a substituted or unsubstituted alkyl, alkenyl, alkynyl, cycloalkyl, heterocycloalkyl, aryl, or heteroaryl group;
R′ is hydrogen or methyl;
x is an integer from 1 to 25,000;
y is an integer from 1 to 500,000;
and n is an integer from 2 to 525,000.

16. A random copolymer defined by the formula below 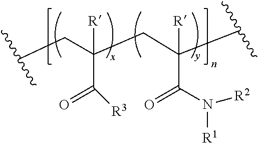
wherein
R¹ and R² are individually hydrogen or substituted or unsubstituted C1-C12 alkyl, C2-C12 alkenyl, C2-C12 alkynyl, cycloalkyl, heterocycloalkyl, aryl, or heteroaryl, or R¹ and R² together with the atom to which they are attached form a substituted or unsubstituted cycloalkyl or heterocycloalkyl ring, with the proviso that only one of R¹ and R² can be hydrogen;
R³ is a substituted or unsubstituted alkyl, alkenyl, alkynyl, cycloalkyl, heterocycloalkyl, aryl, or heteroaryl group;
R′ is hydrogen or methyl;
x is an integer from 1 to 25,000;
y is an integer from 1 to 500,000;
and n is an integer from 2 to 525,000.

17. The copolymer of claim 16, wherein R³ is a substituted or unsubstituted aryl or heteroaryl group.

18. The method of claim 1, wherein the copolymer is UV degradable.

19. A method of producing a UV degradable (meth)acrylamide copolymer, the method comprising:
activating a pendant secondary or tertiary amide moiety present in a (meth)acrylamide (co)polymer to form a keteniminium ion or a nitrilium ion; and
quenching the keteniminium ion or the nitrilium ion with a nucleophile to form a monomer repeat unit is defined by the structure below 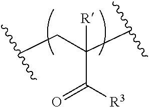
wherein
R³ is a substituted or unsubstituted aryl or heteroaryl group; and
R′ is hydrogen or methyl.

20. The method of claim 19, wherein upon UV irradiation, the UV degradable (meth)acrylamide copolymer can undergo a Norrish type 2 radical fragmentation.

21. A method for recycling an article having a label adhered thereto, wherein the label is adhered to the article with an adhesive composition comprising a copolymer defined by claim 17, the method comprising:
irradiating the adhesive composition with UV light, wherein the UV light triggers degradation of the copolymer, thereby releasing the label adhered to the article.

22. A method for delivering an active agent to a target, the method comprising:
contacting the target with a composition comprising the active agent dispersed in a polymeric matrix comprising the copolymer defined by claim 17; and
irradiating the composition with UV light, wherein the UV light triggers degradation of the copolymer, thereby releasing the active agent.

23. A UV degradable adhesive comprising the copolymer defined by claim 17, optionally wherein the adhesive is used to adhere labels to recyclable articles such as packaging.
